(19) United States
(12) Patent Application Publication
(10) Pub. No.: US 2025/0087910 A1
(43) Pub. Date: Mar. 13, 2025

(54) TERMINAL AND ELECTRIC WIRE WITH TERMINAL

(71) Applicant: Yazaki Corporation, Tokyo (JP)

(72) Inventor: Syunsuke YAOITA, Shizuoka (JP)

(73) Assignee: Yazaki Corporation, Tokyo (JP)

(21) Appl. No.: 18/819,612

(22) Filed: Aug. 29, 2024

(30) Foreign Application Priority Data
Sep. 12, 2023 (JP) 2023-147649

(51) Int. Cl. H01R 4/48; H01R 13/11

(52) U.S. Cl. CPC H01R 4/4814; H01R 13/113

(57) ABSTRACT

A terminal includes: a cylindrical box portion into which a mating terminal is inserted; and a spring portion which extends in a longitudinal direction from a front end portion to a rear end portion of a box portion and deforms in a deflection direction away from the mating terminal when the mating terminal inserted into the box portion comes into contact with the spring portion. The spring portion has a pair of projections projecting outward in a width direction orthogonal to a longitudinal direction from a free end portion of the spring portion on a rear end side. The box portion has a hole which is formed in a pair of side walls constituting the box portion. The hole is formed into an arc shape along a locus where the projection moves when the spring portion with which the mating terminal comes into contact deforms in the deflection direction.

### CROSS-REFERENCE TO RELATED APPLICATIONS

The present application is based on, and claims priority from the prior Japanese Patent Application No. 2023-147649, filed on Sep. 12, 2023, the entire contents of which are incorporated herein by reference.

### TECHNICAL FIELD

The present disclosure relates to a terminal and an electric wire with a terminal.

### BACKGROUND

A terminal (for example, what is known as a crimp terminal) attached to an end of an electric wire is conventionally used. For example, the terminal includes a cylindrical box portion into which a mating terminal is inserted, a cantilever beam-like spring portion provided inside the box portion and having a contact portion with the mating terminal, and a fixing portion for fixing the terminal to the electric wire (see JP2014-160544A).

### SUMMARY OF THE INVENTION

In order to electrically connect the electric wire with a terminal described above and another electric wire, there is a case in which ultrasonic joining processing is performed in a state in which the core wires of both electric wires are brought into close contact with each other, and the core wires of both electric wires are joined to each other. In this case, ultrasonic vibration applied to the joining portion is transmitted to the terminal via the electric wire, which may vibrate the terminal. In particular, since the spring portion is formed in the shape of a cantilever beam, vibration in which upward and downward oscillations are repeated using the fixed end as a fulcrum is likely to occur. Depending on the degree of the vibration, excessive deflection or the like may repeatedly occur in the spring portion, which may cause deterioration or plastic deformation of the spring portion. From the viewpoint of improving the reliability of the electrical connection between the terminal and the mating terminal, it is preferable to suppress such deterioration or the like of the spring portion as much as possible.

An object of the present disclosure is to provide a terminal and an electric wire with a terminal capable of suppressing deformation of a spring portion due to an external force such as vibration applied from the outside.

A terminal according to an embodiment includes: a cylindrical box portion into which a mating terminal is inserted; and a spring portion which extends in a longitudinal direction from a front end portion to a rear end portion of the box portion and deforms in a deflection direction away from the mating terminal when the mating terminal inserted into the box portion comes into contact with the spring portion, in which the spring portion has a pair of projections projecting outward in a width direction orthogonal to the longitudinal direction from a free end portion of the spring portion on a rear end side, the box portion has a hole which is formed in each of a pair of side walls constituting the box portion and into which the projection is inserted and locked, and the hole is formed into an arc shape along a locus where the projection moves when the spring portion with which the mating terminal comes into contact deforms in the deflection direction.

An electric wire with a terminal according to an embodiment includes an electric wire, and a terminal attached to the electric wire, and the terminal includes: a cylindrical box portion into which a mating terminal is inserted; and a spring portion which extends in a longitudinal direction from a front end portion to a rear end portion of the box portion and deforms in a deflection direction away from the mating terminal when the mating terminal inserted into the box portion comes into contact with the spring portion, in which the spring portion has a pair of projections projecting outward in a width direction orthogonal to the longitudinal direction from a free end portion of the spring portion on a rear end side, the box portion has a hole which is formed in a pair of side walls constituting the box portion and into which the projection is inserted and locked, and the hole is formed into an arc shape along a locus where the projection moves when the spring portion with which the mating terminal comes into contact deforms in the deflection direction.

The above configuration makes it possible to provide a terminal and an electric wire with a terminal capable of suppressing deformation of a spring portion due to an external force such as vibration applied from the outside.

### BRIEF DESCRIPTION OF DRAWINGS

FIG. 1 is a perspective view of a main portion illustrating an example of a terminal according to a present embodiment.

FIG. 2 is a side view of the main portion illustrating an example of the terminal according to the present embodiment.

FIG. 3 is a front view illustrating an example of the terminal according to the present embodiment.

FIG. 4 is a cross-sectional view taken along line A-A of FIG. 3.

FIG. 5 is a cross-sectional view taken along line B-B of FIG. 4.

FIG. 6 is a schematic view illustrating an enlarged hole formed in a side wall of the terminal.

FIG. 7 is a schematic cross-sectional view of the terminal illustrating a state before fitting.

FIG. 8 is a schematic cross-sectional view of the terminal illustrating a state after fitting.

FIG. 9 is a schematic view illustrating a method of manufacturing a wire harness having a joining portion in which core wires of a plurality of electric wires with terminals are joined to each other by ultrasonic joining.

FIG. 10 is a schematic view illustrating a method of manufacturing the wire harness having the joining portion in which the core wires of the plurality of electric wires with terminals are joined to each other by ultrasonic joining.

### DETAILED DESCRIPTION OF THE INVENTION

Hereinafter, a terminal and an electric wire with a terminal according to a present embodiment will be described in detail with reference to the drawings. Note that the dimensional ratio of the drawings is exaggerated for the sake of explanation, and may differ from the actual ratio.

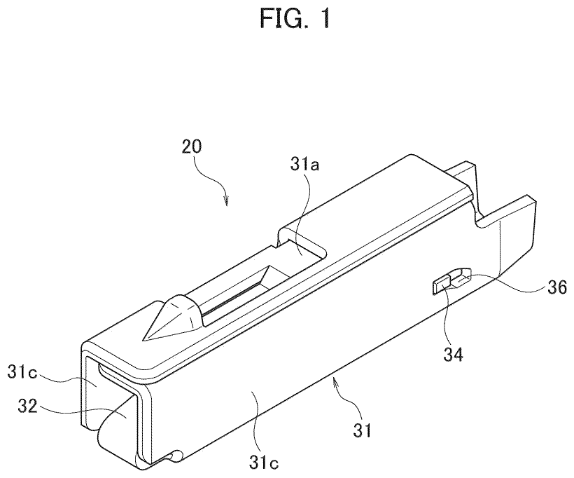

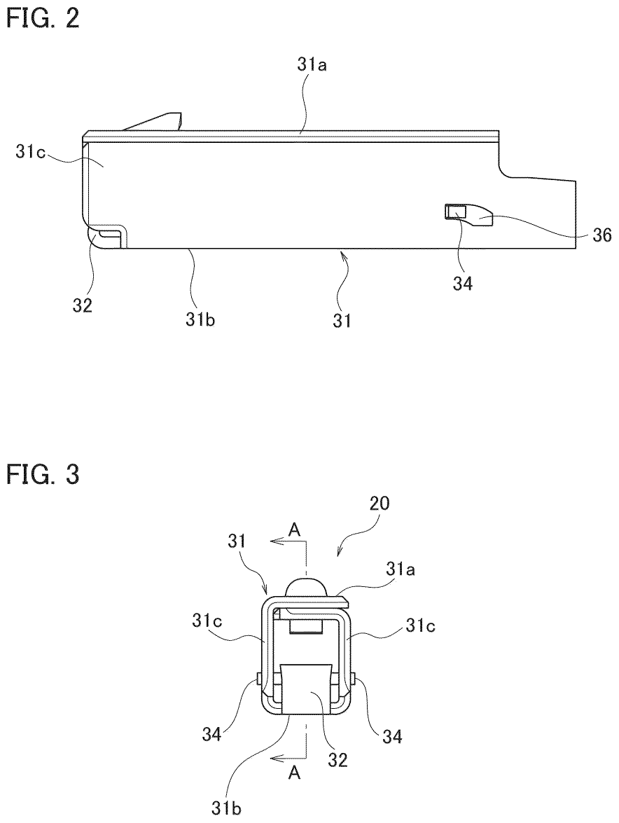

For the sake of convenience of description, a side (left side in FIGS. 1 and 2) to which a mating terminal (male terminal 40) is fitted in a longitudinal direction (fitting direction) of a terminal (female terminal 20) will be referred to as a tip end side (front side), and the opposite side (right side in FIGS. 1 and 2) will be referred to as a proximal end side (rear side). Further, in FIGS. 1 and 2, an upside and a downside will be referred to as an upward side and a downward side, respectively. In addition, a direction orthogonal to the female terminal 20 in the longitudinal direction and the up-down direction of will be referred to as a width direction.

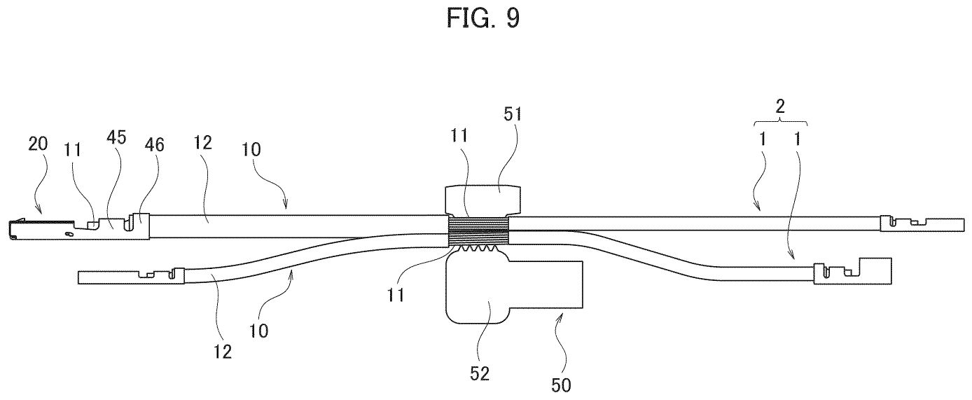

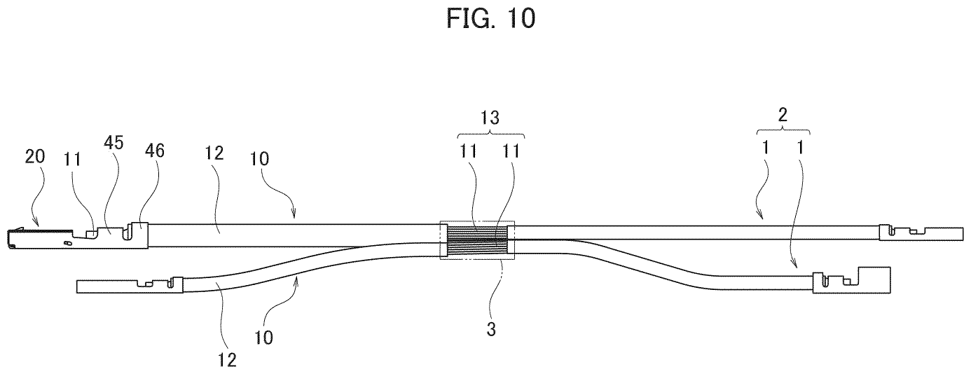

As illustrated in FIGS. 9 and 10, the female terminal 20 is crimped and fixed to the end portion of an electric wire 10, and thus the female terminal 20 and the conductor core wire (core wire 11) of the electric wire 10 are electrically connected to each other. The electric wire 10 and the female terminal 20 constitute an electric wire with a terminal 1, and the electric wire with a terminal 1 constitutes a wire harness 2 (see FIG. 10) that is routed in a vehicle such as an automobile.

The electric wire 10 is an insulated electric wire having the core wire 11 and a coating 12, which is made of resin, for covering the core wire 11. For example, the core wire 11 is formed by twisting a plurality of electric wires made of aluminum or an aluminum alloy. By forming the core wire 11 of the electric wire 10 using aluminum or an aluminum alloy, the electric wire with a terminal 1 is reduced in weight, and the wire harness 2 formed by including the electric wire with a terminal 1 is also reduced in weight. In particular, the electric wire with a terminal 1, which is reduced in weight, is suitably used for vehicles in which the wire harness is frequently used, such as electric vehicles and hybrid vehicles. The core wire 11 is not limited to being formed by using aluminum or an aluminum alloy, and may be formed by using other materials (such as, copper or copper alloy).

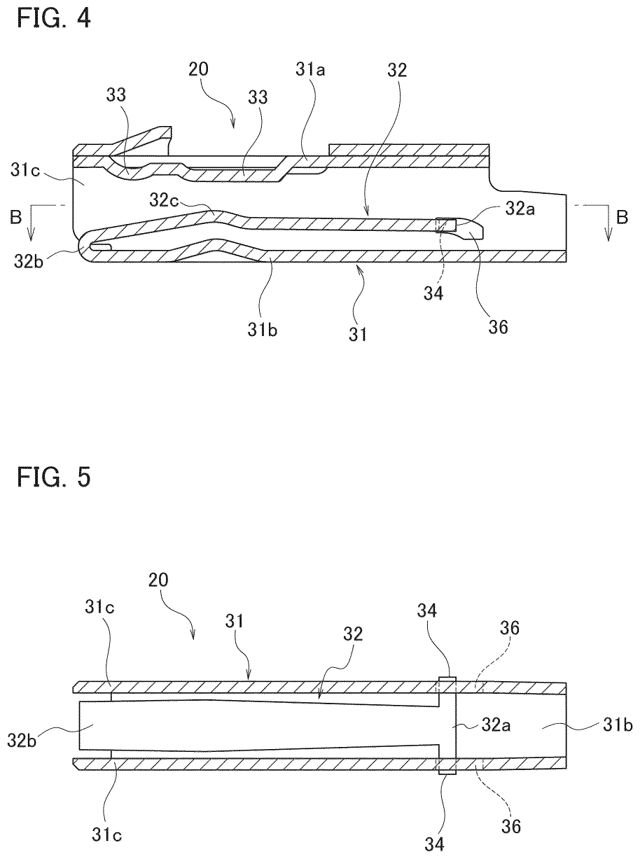

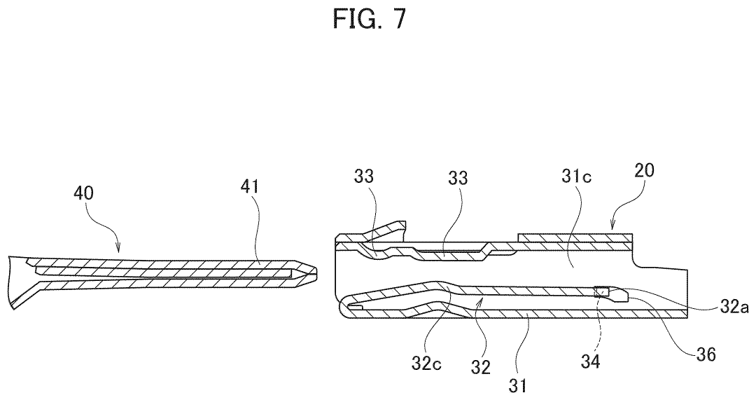

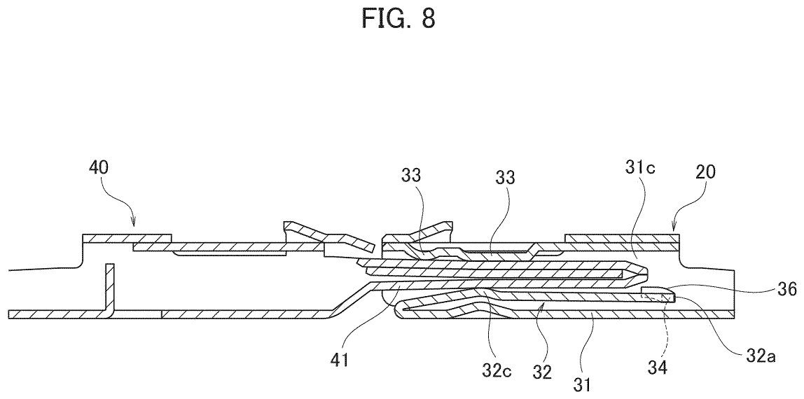

As illustrated in FIGS. 1 to 5, the female terminal 20 includes a box portion 31 at the tip end side into which a conductive contact portion 41 (see FIGS. 7 and 8) of the mating terminal (male terminal 40) is inserted. In addition, the female terminal 20 includes, at the proximal end side of the box portion 31, a first barrel portion (core wire crimping piece 45) crimped to the core wire 11 exposed from the end portion of the electric wire 10, and a second barrel portion (coating crimping piece 46) crimped to the coating 12 that is positioned at the end portion of the electric wire 10 (see FIGS. 9 and 10).

The female terminal 20 is formed by performing press working (punching and bending) or the like on a metal plate (plate-like body). For example, the female terminal 20 is formed of a metal material different from the core wire 11 which is formed of aluminum or an aluminum alloy. Specifically, the female terminal 20 is formed using a metal plate (plate-like body), which is constituted of copper or a copper alloy or the like, as a base material. The core wire 11 of the electric wire 10 and the female terminal 20 are not necessarily formed of different metal materials, and may be formed of the same metal material.

After the press working described above, the female terminal 20 is preferably plated before being crimped to the electric wire 10 for the purpose of suppressing corrosion of the core wire 11 of the electric wire 10 to improve corrosion resistance. For example, the female terminal 20 before being crimped to the electric wire 10 is plated with tin (Sn). Specifically, the female terminal 20 is provided with a plating layer containing tin so as to cover the side surfaces formed from the cut surface formed by the press working and the outside and inside surfaces. The surfaces of the female terminal 20 are not limited to plating with tin (Sn), and may be plated with another material (for example, gold (Au), silver (Ag), nickel (Ni), and an alloy thereof).

The box portion 31 has a rectangular cylindrical shape extending in the front-rear direction and penetrating in the front-rear direction. The box portion 31 includes an upper wall 31a, a bottom wall 31b, and a pair of side walls 31c and 31c, and a spring portion (contact spring 32) is integrally formed inside the box portion 31. The contact spring 32 is a cantilever beam-like plate spring extending from the tip end portion of the bottom wall 31b of the box portion 31, and extending from the tip end side toward the proximal end side inside the box portion 31. In addition, the contact spring 32 is elastically deformable in the up-down direction. Further, the contact spring 32 extends from the proximal end portion of the box portion 31 to a predetermined position on the tip end side. For this reason, a free end portion 32a of the contact spring 32 is positioned inside the box portion 31.

The contact spring 32 is formed with a contact portion 32c in contact with the conductive contact portion 41 of the male terminal 40 at a portion near the fixed end portion 32b of the contact spring 32 (the tip end portion of the box portion 31). The contact portion 32c projects upward and extends in the width direction. A terminal portion 33 is formed inside the box portion 31 at a part facing the contact portion 32c of the contact spring 32. The terminal portion 33 projects downward and extends in the width direction. When the conductive contact portion 41 of the male terminal 40 (see FIG. 7) is inserted from the tip end opening of the box portion 31, the conductive contact portion 41 pushes down the contact portion 32c of the contact spring 32, thereby housing the conductive contact portion 41 inside the box portion 31 in a state where the contact spring 32 is elastically deformed downward. Thus, the contact portion 32c of the female terminal 20 and the conductive contact portion 41 of the male terminal 40 are maintained in contact with each other, thereby electrically connecting the terminal (female terminal 20) and the mating terminal (male terminal 40) with each other (see FIG. 8).

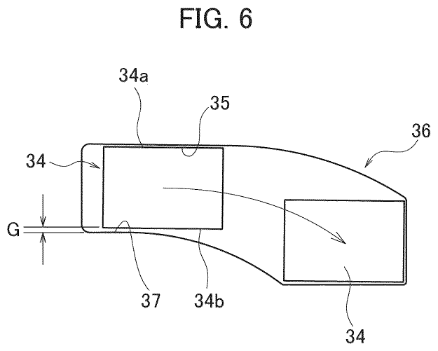

The contact spring 32 is formed with a pair of projections 34 and 34 integrally formed and projecting outward in the width direction from the free end portion 32a of the contact spring 32. Meanwhile, a hole 36 into which the projection 34 is inserted and locked is formed in the pair of side walls 31c and 31c of the box portion 31. In the present embodiment, the hole 36 is formed into an arc shape along a locus where the projection 34 moves when the contact spring 32 with which the conductive contact portion 41 of the male terminal 40 comes into contact deforms in the deflection direction (see FIG. 6).

In the present embodiment, as illustrated in FIG. 6, the hole 36 has a holding surface portion 35 which is formed in the peripheral edge of the hole 36 and holds the contact spring 32 in a state elastically deformed in the deflection direction from the natural state. In the present embodiment, the projection 34 formed on the contact spring 32 is brought into contact with the holding surface portion 35 formed in the hole 36. For this reason, the contact spring 32 is held in a state elastically deformed in the deflection direction from the natural state by the holding surface portion 35, thereby urging the free end portion 32a of the contact spring 32 upward. In a state in which the upper surface 34a of the projection 34 comes in contact with the upper wall surface of the hole 36 (holding surface portion 35), the gap G between the lower surface 34b of the projection 34 and the lower wall surface 37 of the hole 36 is set to about 0.1 mm, for example.

Further, the female terminal 20 includes a fixing portion for fixing the female terminal 20 to the electric wire 10. The fixing portion has the first barrel portion (core wire crimping piece 45) and the second barrel portion (coating crimping piece 46) (see FIGS. 9 and 10). A pair of core wire crimping pieces 45 extending upward before being crimped to the electric wire 10 are formed on the pair of side walls 31c and 31c belonging to the first barrel portion. Meanwhile, a pair of coating crimping pieces 46 extending upward before being crimped to the electric wire 10 are formed on the pair of side walls 31c and 31c belonging to the second barrel portion.

As illustrated in FIGS. 9 and 10, the electric wire 10 is arranged in the female terminal 20 before being crimped to the electric wire 10 such that the core wire 11 exposed from the end portion of the electric wire 10 is sandwiched between the pair of core wire crimping pieces 45 and the coating 12 that is the end portion of the electric wire 10 is sandwiched between the pair of coating crimping pieces 46. In this state, the pair of core wire crimping pieces 45 and the pair of the coating crimping piece 46 are crimped using a predetermined crimping machine, thereby obtaining the electric wire with a terminal 1 illustrated in FIGS. 9 and 10.

The electric wire with a terminal 1 illustrated in FIGS. 9 and 10 constitutes, for example, the wire harness 2. As illustrated in FIG. 10, the wire harness 2 has a branch connection portion (joining portion 13) in which the exposed core wires 11 of the electric wires 10 of the plurality of electric wires with terminals 1 (in the figure, two electric wires with terminals 1) are ultrasonically joined to each other. The wire harness 2 may have a joining portion 13 in which the exposed core wires 11 of three or more electric wires 10 are ultrasonically joined to each other. Further, a terminal other than the female terminal 20 may be attached to some of the electric wires 10 constituting the wire harness 2, or a terminal may not be attached thereto.

A joining machine 50 used for forming the joining portion 13 will be described below.

As illustrated in FIG. 9, the joining machine 50 includes a pair of joining indenters (what is known as an anvil 51 and an horn 52) facing each other in the up-down direction, and a control device (not illustrated) for controlling joining energy (ultrasonic excitation) applied between the pair of joining indenters (anvil 51 and horn 52). A joining space is defined by the pair of joining indenters (anvil 51 and horn 52), and the exposed core wires 11 of the plurality of electric wires 10 are arranged in the joining space.

In a state in which a plurality of core wires 11 are sandwiched between the anvil 51 and the horn 52, energy (ultrasonic excitation) of a predetermined magnitude is applied between the anvil 51 and the horn 52. By performing ultrasonic joining processing on the plurality of core wires 11 in this way, the joining portion 13 in which the plurality of core wires 11 are joined is formed (see FIG. 10).

On the outer surface of the joining portion 13 of the plurality of core wires 11 joined to each other, a joining mark due to ultrasonic joining is formed. In the present embodiment, the joining mark has a shape in which the unevenness of the surfaces of the anvil 51 and the horn 52 used for ultrasonic joining is transferred, and is recognizable from the outer surface of the joining portion 13.

Further, it is preferable that the protective member 3, which is illustrated by a two dot chain line in FIG. 10, is mounted on the joining portion 13 of the plurality of core wires 11 joined to each other so as to cover the entire outer surface of the joining portion 13. Thus, damage to the joining portion 13 caused by the joining portion 13 coming into contact with the surrounding members can be suppressed, and occurrence of an unintentional short circuit caused by the joining portion 13 coming into contact with the surrounding conductive members can be suppressed.

As described above, the terminal (female terminal 20) according to the present embodiment includes the cylindrical box portion 31 into which the mating terminal (male terminal 40) is inserted. The terminal (female terminal 20) includes the spring portion (contact spring 32) which extends in the longitudinal direction from the front end portion to the rear end portion of the box portion 31 and deforms in the deflection direction away from the mating terminal (male terminal 40) when the mating terminal (male terminal 40) inserted into the box portion 31 comes into contact with the spring portion. The spring portion (contact spring 32) has a pair of projections 34 and 34 projecting outward in the width direction orthogonal to the longitudinal direction from the free end portion 32a of the spring portion (contact spring 32) on the rear end side. The box portion 31 has the hole 36 which is formed in the pair of side walls 31c and 31c constituting the box portion 31 and into which the projection 34 is inserted and locked. The hole 36 is formed into an arc shape along a locus where the projection 34 moves when the spring portion (contact spring 32) with which the mating terminal (male terminal 40) comes into contact deforms in the deflection direction.

In the present embodiment, the projection 34 formed on the contact spring 32 is locked into the hole 36 formed in the side wall 31c of the box portion 31, and the contact spring 32 deforms in the up-down direction within a range where the projection 34 comes into contact with the upper wall surface (holding surface portion 35) or the lower wall surface 37 of the hole 36. In addition, the hole 36 formed in the side wall 31c of the box portion 31 is formed based on a locus drawn by the projection 34 when the contact spring 32 deforms elastically in the deflection direction by means of the conductive contact portion 41 of the male terminal 40 inserted into the box portion 31. For this reason, the movement of the projection 34 directly upward or directly downward is restricted by the peripheral edge (upper wall surface, and lower wall surface 37) of the hole 36. Thus, the contact spring 32 in which the projection 34 is inserted and locked into the hole 36 does not deform even toward the rear side of the box portion 31 in the longitudinal direction unless an external force is applied to the projection 34. This makes it possible to suppress deformation of the contact spring 32 in the deflection direction due to an external force other than the force acting on the contact spring 32 when the conductive contact portion 41 of the male terminal 40 is inserted into the box portion 31.

As described above, the present embodiment makes it is possible to provide the terminal (female terminal 20) capable of suppressing deformation of the spring portion (contact spring 32) due to an external force such as vibration applied from the outside.

In the terminal (female terminal 20), the hole 36 may have the holding surface portion 35 which is formed in the peripheral edge of the hole 36 and holds the spring portion (contact spring 32) in a state elastically deformed in the deflection direction from the natural state.

In the present embodiment, in a case where the projection 34 is inserted and locked into the hole 36, the contact spring 32 elastically deforms in the deflection direction (downward), which brings the projection 34 formed on the contact spring 32 and the holding surface portion 35 formed in the peripheral edge of the hole 36 into contact with each other. By bringing the projection 34 formed on the contact spring 32 and the holding surface portion 35 formed in the peripheral edge of the hole 36 into contact with each other, it is possible to suppress upward deformation of the contact spring 32 due to an external force such as ultrasonic vibration during ultrasonic joining. In addition, an elastic force (biasing force) is generated in the contact spring 32, and the contact spring 32 does not deform unless an external force equal to or greater than the elastic force (biasing force) generated in the contact spring 32 is applied even in the downward direction, and thus the contact spring 32 hardly deforms even in the downward direction.

Further, the electric wire with a terminal 1 according to an aspect of the present embodiment is provided with the electric wire 10, and the terminal (female terminal 20) attached to the electric wire 10. The terminal (female terminal 20) includes the cylindrical box portion 31 into which the mating terminal (male terminal 40) is inserted. The terminal (female terminal 20) includes the spring portion (contact spring 32) which extends in the longitudinal direction from the front end portion to the rear end portion of the box portion 31 and deforms in the deflection direction away from the mating terminal (male terminal 40) when the mating terminal (male terminal 40) inserted into the box portion 31 comes into contact with the spring portion. The spring portion (contact spring 32) has a pair of projections 34 and 34 projecting outward in the width direction orthogonal to the longitudinal direction from the free end portion 32a of the spring portion (contact spring 32) on the rear end side. The box portion 31 has the hole 36 which is formed in the pair of side walls 31c and 31c constituting the box portion 31 and into which the projection 34 is inserted and locked. The hole 36 is formed into an arc shape along a locus where the projection 34 moves when the spring portion (contact spring 32) with which the mating terminal (male terminal 40) comes into contact deforms in the deflection direction.

In the present embodiment, the projection 34 formed on the contact spring 32 is locked into the hole 36 formed in the side wall 31c of the box portion 31, and the contact spring 32 deforms in the up-down direction within a range where the projection 34 comes into contact with the upper wall surface (holding surface portion 35) or the lower wall surface 37 of the hole 36. In addition, the hole 36 formed in the side wall 31c of the box portion 31 is formed based on a locus drawn by the projection 34 when the contact spring 32 deforms elastically in the deflection direction by means of the conductive contact portion 41 of the male terminal 40 inserted into the box portion 31. For this reason, the movement of the projection 34 directly upward or directly downward is restricted by the peripheral edge (upper wall surface, and lower wall surface 37) of the hole 36. Thus, the contact spring 32 in which the projection 34 is inserted and locked into the hole 36 does not deform even toward the rear side of the box portion 31 in the longitudinal direction unless an external force is applied to the projection 34. This makes it possible to suppress deformation of the contact spring 32 in the deflection direction due to an external force other than the force acting on the contact spring 32 when the conductive contact portion 41 of the male terminal 40 is inserted into the box portion 31. Since the contact spring 32 is hardly deformed by an external force that is generated at the time of manufacturing the wire harness 2, such as ultrasonic joining, the ultrasonic joining method described above can be applied to the electric wire with a terminal 1 without deteriorating the electrical contact reliability.

As described above, the present embodiment makes it possible to provide the electric wire with a terminal 1 capable of suppressing deformation of the spring portion (contact spring 32) due to an external force such as vibration applied from the outside.

In the electric wire with a terminal 1, the hole 36 may have the holding surface portion 35 which is formed in the peripheral edge of the hole 36 and holds the spring portion (contact spring 32) in a state elastically deformed in the deflection direction from the natural state.

In the present embodiment, in a case where the projection 34 is inserted and locked into the hole 36, the contact spring 32 elastically deforms in the deflection direction (downward), which brings the projection 34 formed on the contact spring 32 and the holding surface portion 35 formed in the peripheral edge of the hole 36 into contact with each other. By bringing the projection 34 formed on the contact spring 32 and the holding surface portion 35 formed in the peripheral edge of the hole 36 into contact with each other, it is possible to suppress upward deformation of the contact spring 32 due to an external force such as ultrasonic vibration during ultrasonic joining. In addition, an elastic force (biasing force) is generated in the contact spring 32, and the contact spring 32 does not deform unless an external force equal to or greater than the elastic force (biasing force) generated in the contact spring 32 is applied even in the downward direction, and thus the contact spring 32 hardly deforms even in the downward direction.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A terminal comprising:
a cylindrical box portion into which a mating terminal is inserted; and
a spring portion which extends in a longitudinal direction from a front end portion to a rear end portion of the box portion and deforms in a deflection direction away from the mating terminal when the mating terminal inserted into the box portion comes into contact with the spring portion, wherein
the spring portion has a pair of projections projecting outward in a width direction orthogonal to the longitudinal direction from a free end portion of the spring portion on a rear end side,
the box portion has a hole which is formed in each of a pair of side walls constituting the box portion and into which the projection is inserted and locked, and
the hole is formed into an arc shape along a locus where the projection moves when the spring portion with which the mating terminal comes into contact deforms in the deflection direction.

2. The terminal according to claim 1,
wherein the hole has a holding surface portion which is formed in a peripheral edge of the hole and holds the spring portion in a state elastically deformed in the deflection direction from a natural state.

3. An electric wire with a terminal comprising:
an electric wire, and a terminal attached to the electric wire, and
the terminal includes:
a cylindrical box portion into which a mating terminal is inserted; and
a spring portion which extends in a longitudinal direction from a front end portion to a rear end portion of the box portion and deforms in a deflection direction away from the mating terminal when the mating terminal inserted into the box portion comes into contact with the spring portion, wherein
the spring portion has a pair of projections projecting outward in a width direction orthogonal to the longitudinal direction from a free end portion of the spring portion on a rear end side,
the box portion has a hole which is formed in a pair of side walls constituting the box portion and into which the projection is inserted and locked, and
the hole is formed into an arc shape along a locus where the projection moves when the spring portion with which the mating terminal comes into contact deforms in the deflection direction.

4. The electric wire with a terminal according to claim 3,
wherein the hole has a holding surface portion which is formed in a peripheral edge of the hole and holds the spring portion in a state elastically deformed in the deflection direction from a natural state.
